(19) United States
(12) Patent Application Publication
(10) Pub. No.: US 2024/0127243 A1
(43) Pub. Date: Apr. 18, 2024

(54) INFORMATION DISPLAY

(71) Applicant: ALIPAY.COM CO., LTD., Shanghai (CN)

(72) Inventor: Shengqun ZOU, Shanghai (CN)

(21) Appl. No.: 18/394,972

(22) Filed: Dec. 22, 2023

Related U.S. Application Data
(63) Continuation of application No. PCT/CN2022/107824, filed on Jul. 26, 2022.

(30) Foreign Application Priority Data
Sep. 26, 2021 (CN) 202111131542.9

(51) Int. Cl. G06Q 20/40; G06Q 20/32; G06Q 20/38; H04L 9/40; H04W 12/71

(52) U.S. Cl. CPC G06Q 20/4014; G06Q 20/3276; G06Q 20/3278; G06Q 20/382; G06Q 20/4015; H04L 63/0876; H04W 12/71

(57) ABSTRACT

Implementations of the present specification disclose an information display method, apparatus, and device. The solution includes the following: At least one device identifier that is found based on a Bluetooth manner and that is sent by a user terminal is obtained; merchant identification information corresponding to the at least one device identifier is determined; the merchant identification information is sent to a payment merchant selection interface of the user terminal for display; and a user can select, in the payment merchant selection interface of the user terminal, merchant identification information for making a payment, to jump to a payment interface to make a payment.

### TECHNICAL FIELD

The present application relates to the field of Internet technologies, and in particular, to an information display method, apparatus, and device.

### BACKGROUND

With emergence of Internet payments, people more frequently use mobile phones to make mobile payments. The mobile payment provides people with a simple and quick payment method. Such a payment method is a payment mode that satisfies consumer requirements. Because of such advantages and features, the mobile payment is gaining the favor of increasingly more smartphone users.

However, currently, although it is quick and convenient to make a payment by using the mobile phone, there is a great security risk involved in such a payment practice because a mobile phone of a customer is bound to a bank card, and a payment can be completed by using a simple payment password. If the mobile phone of the customer is lost, a great economic loss may be caused to the customer. In addition, the mobile payment usually needs to be made by scanning a two-dimensional code, and is prone to be affected by application scenarios. For example, when scanning of the two-dimensional code is affected, payment efficiency is reduced.

### SUMMARY

Implementations of the present specification provide an information display method, apparatus, and device, which, among others, resolve a problem of low payment efficiency and low security in an existing method.

The implementations of the present specification, which resolve the above technical problem, are implemented as follows: an implementation of the present specification provides an information display method, including: obtaining at least one device identifier that is found based on a Bluetooth manner and that is sent by a user terminal; determining merchant identification information corresponding to the at least one device identifier; and sending the merchant identification information to a payment merchant selection interface of the user terminal for display, where the payment merchant selection interface is configured to provide the user terminal with merchant identification information that can be selected to make a payment.

An implementation of the present specification provides an information display apparatus, including: a device identifier acquisition module, configured to obtain at least one device identifier that is found based on a Bluetooth manner and that is sent by a user terminal; a merchant identification information determining module, configured to determine merchant identification information corresponding to the at least one device identifier; and a merchant identification information display module, configured to send the merchant identification information to a payment merchant selection interface of the user terminal for display, where the payment merchant selection interface is configured to provide the user terminal with merchant identification information that can be selected to make a payment.

An implementation of the present specification provides an information display device, including at least one processor and a storage communicatively connected to the at least one processor. The storage stores instructions that can be executed by the at least one processor. The instructions are executed by the at least one processor, to enable the at least one processor to perform the following operations: obtaining at least one device identifier that is found based on a Bluetooth manner and that is sent by a user terminal; determining merchant identification information corresponding to the at least one device identifier; and sending the merchant identification information to a payment merchant selection interface of the user terminal for display, where the payment merchant selection interface is configured to provide the user terminal with merchant identification information that can be selected to make a payment.

An implementation of the present specification provides a computer-readable medium. The computer-readable medium stores computer-readable instructions. The computer-readable instructions can be executed by a processor to implement the information display method.

At least one implementation of the present specification can achieve the following beneficial effects: The at least one device identifier that is found based on the Bluetooth manner and that is sent by the user terminal is obtained; the merchant identification information corresponding to the at least one device identifier is determined; the merchant identification information is sent to the payment merchant selection interface of the user terminal for display; and a user can select, in the payment merchant selection interface of the user terminal, merchant identification information for making a payment, to jump to a payment interface to make a payment. In an entire process, the user does not need to turn on a camera to perform a scanning operation, and the user directly selects, in the interface of the user terminal, the merchant identification information that needs to be paid to complete a payment. This can improve payment efficiency and a payment success rate of the user.

### BRIEF DESCRIPTION OF DRAWINGS

To describe the technical solutions in implementations of the present specification more clearly, the following is a brief introduction of the accompanying drawings which help to describe the implementations of the specification. Clearly, the accompanying drawings described below are merely some implementations of the present application, and a person of ordinary skill in the art can derive other drawings from such accompanying drawings without making innovative efforts.

FIG. 1 is a schematic flowchart illustrating a scenario of making a payment through code scanning in the existing technologies;

FIG. 2 is an overall schematic diagram illustrating an information display method according to an implementation of the present specification;

FIG. 3 is a schematic flowchart illustrating an information display method according to an implementation of the present specification;

FIG. 4 is a lane diagram illustrating an information prompting method according to an implementation of the present specification;

FIG. 5 is a schematic diagram illustrating a structure of an information display apparatus according to an implementation of the present specification; and

FIG. 6 is a schematic diagram illustrating a structure of an information display device according to an implementation of the present specification.

### DESCRIPTION OF IMPLEMENTATIONS

To make the technical features, technical solutions, and technical benefits of one or more implementations of the present specification more clearly, the following clearly and comprehensively describes the technical solutions in the one or more implementations of the present specification with reference to corresponding accompanying drawings and implementations of the present specification. Clearly, the described implementations are merely some rather than all of implementations of the present specification. All other implementations obtained by a person of ordinary skill in the art based on the implementations of the present specification without making innovative efforts fall within the protection scope of the one or more implementations of the present specification.

The technical solutions provided in the implementations of the present specification are described in detail below with reference to the accompanying drawings.

The security issue of mobile payment is an important factor that affects development of the mobile payment. For example, when a user displays a two-dimensional code to make a payment, information about the two-dimensional code is prone to be stolen, resulting in a problem of illegal theft of user data and a danger to property security. In addition, mobility of a mobile device increases a risk of loss, and there is a potential risk that a mobile phone is illegally used to make a payment after being lost, which are important problems that the mobile payment need to face.

In an existing technology of making a secure payment by using a mobile phone, a card is swiped and a password is entered online. For example, a relatively typical Lakala card reader is used in China. In this solution, although the mobile phone does not need to be bound to a bank card, a customer adds a corresponding card reader to a PC or the mobile phone, so that the mobile phone and a physical card are used together. A magnetic stripe card can be easily copied, and the card reader increases payment costs of the user. In this card swiping manner, there is still a relatively large disadvantage in security and quickness. While a security issue in a process of making a payment by using the mobile phone is avoided, payment costs of the customer are increased. In addition, problems such as manual participation and low payment efficiency exist in a use process, and consequently an actual requirement for making a quick payment by using the mobile phone cannot be better satisfied.

With development of mobile technologies, a method for making a payment by scanning a two-dimensional code gradually replaces a conventional method for making a payment through card swiping. However, there are still many problems in the method for making a payment through code scanning. For example, a screen of a mobile phone needs to be exposed in public, a camera is relatively greatly affected by light and a distance, and a payment cannot be completed when a network is poor.

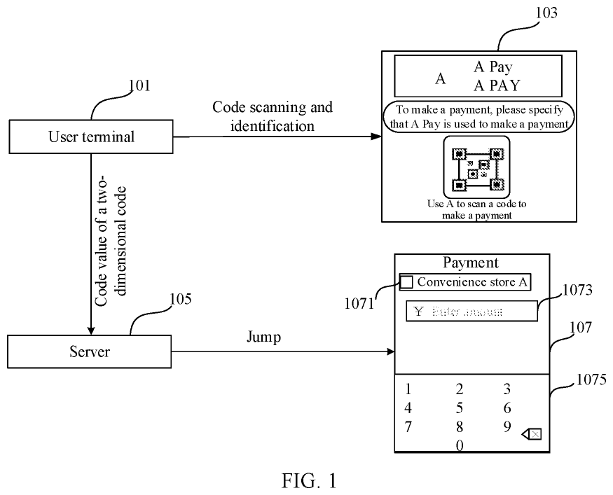

FIG. 1 is a schematic flowchart illustrating a scenario of making a payment through code scanning in the technologies. As shown in FIG. 1, involved interaction subjects can include a user terminal 101, a merchant 103, and a server 105. The server 105 can be a server corresponding to a payment application. The merchant 103 can display a collection code, and the collection code can be a carried code image at a carrier layer of the merchant 103. For example, the merchant 103 affixes the printed payment code to a paper or plastic carrier. In this case, the carrier layer can be the paper or plastic carrier. If the payment code is displayed in a display picture of an electronic screen, the carrier layer can be a layer that is in software that displays the picture and that is used to display the payment code and related information of the payment code. It should be noted that the carrier layer used to carry the code image includes information related to the code image. For example, the carrier layer can have a background color, and there can be a text, an image, an identifier, and the like at the carrier layer. After scanning and identifying the payment code of the merchant 103, the user terminal 101 sends code value information of the two-dimensional code that is obtained through scanning to the server 105. The server 105 can generate a payment interface 107, and send the payment interface 107 to the user terminal 101. The user terminal jumps to the payment interface 107. The payment interface can include store name information 1071 of the merchant, an amount input box 1073, and a numeric keyboard area 1075.

In this method for making a payment through code scanning, there are many problems. For example, a camera of the user terminal is relatively greatly affected by light and a distance. When there is relatively dark light, and the two-dimensional code is damaged or shielded, payment efficiency and a payment success rate of making a payment through code scanning are severely affected. A network also affects the method for making a payment through code scanning. For example, a payment cannot be completed when the network is poor. In addition, in practice, the two-dimensional code can be maliciously replaced. Consequently, a user makes a payment to another account and a capital loss is caused to the merchant.

Therefore, this specification provides solutions for matching a merchant based on short-range communication, e.g., Bluetooth, for display and payment. As a common short-range communication technology, Bluetooth has a communication distance that can be longer than 10 meters, and almost all smartphones support Bluetooth.

The information display method provided in the implementations of the present specification is described in detail herein with reference to the accompanying drawings.

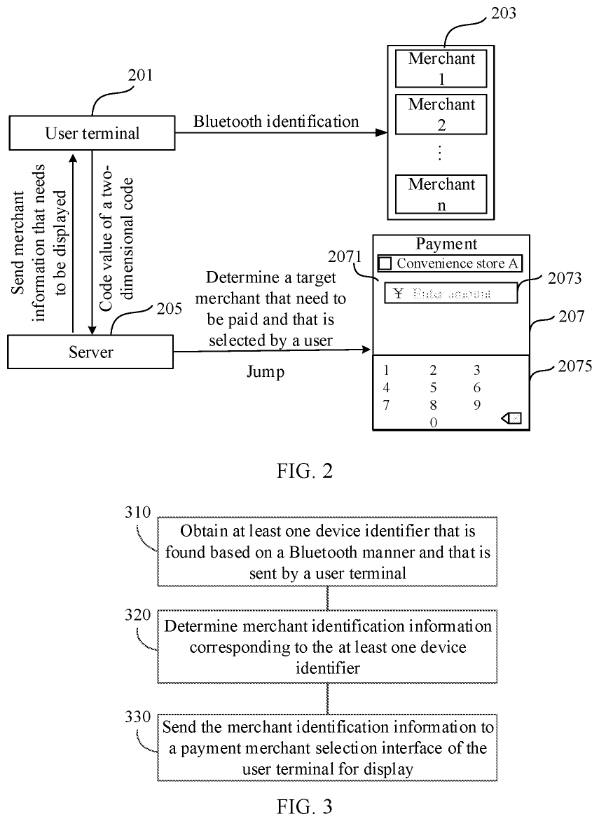

FIG. 2 is an overall schematic diagram illustrating an information display method according to an implementation of the present specification. As shown in FIG. 2, involved interaction subjects can include a user terminal 201, a merchant 203, and a server 205. The server 205 can be a server corresponding to a payment application. The user terminal 201 can automatically find a plurality of device identifiers. The plurality of device identifiers can include device identifiers of a plurality of merchants, for example, a merchant 1, a merchant 2, . . . , and a merchant n. The user terminal 201 sends the found device identifier to the server 205. The server 205 obtains, through screening, a merchant device identifier corresponding to the merchant, determines merchant identification information corresponding to the merchant device identifier, and sends the merchant identification information to the user terminal 201 for display. A user selects target merchant identification information, and jumps to a payment interface 207 to make a payment. The payment interface 207 can include store name information 2071 of a target merchant, an amount input box 2073, and a numeric keyboard area 2075.

FIG. 3 is a schematic flowchart illustrating an information display method according to an implementation of the present specification. From a program perspective, the procedure can be performed by a program or an application client that is loaded on an application server. In some implementations, the procedure can be performed by a server of a payment application. The server can provide a user terminal and a merchant with a transaction platform to complete a transaction.

As shown in FIG. 3, the procedure can include the following steps.

Step 310: Obtain at least one device identifier that is found based on a short range communication like Bluetooth or near field communication NFC and that is sent by the user terminal. In the description herein, Bluetooth is used as an illustrative example of short-range communication for descriptive purposes, which does not limit the scope of the specification.

The user terminal can be an intelligent terminal (for example, a mobile phone or a tablet computer) in which a camera is installed.

A Bluetooth technology is actually a short-range radio technology. By using the Bluetooth technology, communication between mobile communication terminal devices such as a palmtop computer, a laptop computer, and a mobile phone can be effectively simplified, and communication between these devices and the Internet can be successfully simplified. Information transmission between a plurality of communication and information systems is established within a small range by using advanced technologies such as frequency-hopping spread spectrum (FHSS), time division multiple access (TDMA), and code division multiple access (CDMA).

After a Bluetooth function of the user terminal is enabled, a device within a determined range can be automatically searched for via the Bluetooth channel. The device identifier can be an identifier of a device whose Bluetooth function is enabled and that is within a Bluetooth search range of the user terminal. The device identifier can uniquely represent a certain device.

Step 320: Determine merchant identification information corresponding to the at least one device identifier.

In some implementations, the device automatically found by the user terminal can include a merchant device and a personal device. A user can open an application interface of the payment application by using the user terminal, and open a Bluetooth payment application in the application interface. After opening the Bluetooth payment application, the user terminal can automatically enable the Bluetooth search function to search for a Bluetooth device within the determined range, and send a device identifier of the found Bluetooth device to the server of the payment application. The server can determine a merchant device identifier in the device identifier by using the device identifier sent by the user terminal. In this case, the merchant device identifier can be a character string obtained through conversion based on a collection code of the merchant. After the merchant device identifier is determined, corresponding merchant information is determined based on the merchant device identifier. When the merchant information is determined, the following approaches can be used.

Approach 1: The merchant information is determined based on a pre-stored correspondence or mapping between a device identifier and merchant identification information. The determining the merchant identification information corresponding to the at least one device identifier can, for example, include: determining a merchant device identifier corresponding to at least one merchant from the at least one device identifier; and determining merchant identification information corresponding to the merchant device identifier based on the merchant device identifier. The merchant identification information can include a merchant name, distance information of the merchant, profile information of the merchant, and/or the like.

The determining the merchant identification information corresponding to the merchant device identifier based on the merchant device identifier, for example, includes: obtaining the pre-stored correspondence between the device identifier and the merchant identification information; and determining the merchant identification information corresponding to the at least one device identifier based on the correspondence.

In the approach, the server can pre-store the correspondence between the merchant device identifier and the merchant identification information, and after determining the merchant device identifier found by the user terminal, can further determine the merchant identification information corresponding to the device identifier based on the correspondence.

In the above step, when the merchant device identifier is determined from the at least one device identifier, because the merchant device identifier can be a character string obtained through conversion based on a collection two-dimensional code, the merchant device identifier in the device identifier can be identified based on a character string identification rule. For example, if the merchant device identifier has a determined generation rule, when the merchant device identifier is identified from the device identifier, the merchant device identifier can be identified based on the generation rule of the merchant device identifier. Certainly, in practice, the character string obtained through conversion based on the collection two-dimensional code of the merchant can be directly used as the merchant device identifier, or the character string can be processed and then used as the merchant device identifier. For example, the character string can be encrypted based on a symmetric encryption algorithm, and encrypted information is used as the merchant device identifier.

Approach 2: The character string is directly parsed to identify merchant information included in the character string. The determining the merchant identification information corresponding to the at least one device identifier can, for example, include: parsing the character string corresponding to the device identifier to determine merchant identification information included in the character string.

The character string is a character string obtained through conversion based on the collection two-dimensional code of the merchant. When the collection two-dimensional code is generated, store name information and account information of the merchant is used as information in valid information bits in the two-dimensional code. Therefore, based on a rule of generating a collection two-dimensional code, the character string can be parsed to determine whether the character string includes the merchant information, and if yes, the character string is the merchant device identifier. Certainly, if the device identifier is identification information obtained after the character string is encrypted, the character string can be first decrypted based on a decryption method, and then the merchant information in the decrypted character string is obtained through parsing.

Step 330: Send the merchant identification information to a payment merchant selection interface of the user terminal for display, where the payment merchant selection interface is configured to provide the user terminal with merchant identification information that can be selected to make a payment.

The device identifier found by the user terminal can include only one merchant device identifier, a plurality of merchant device identifiers, or no merchant device identifier. However, in practice, if a device of a merchant is not faulty, when making a payment in a physical merchant, the user terminal can find at least one merchant device identifier.

After determining the merchant identification information found by the user terminal, the server can display the merchant identification information in the payment merchant selection interface of the user terminal for the user to view. The user selects, from the merchant identification information displayed in the payment merchant selection interface, the merchant identification information that needs to be paid. The payment merchant selection interface can include merchant identification information of a plurality of merchants, and provides a corresponding function option. The function option can be a virtual location at which a profile of the merchant is located, can be a virtual location at which a name of the merchant is located, or can be an option box independently set near each piece of merchant identification information. For example, when tapping profile information of a corresponding merchant, the user can jump to a corresponding payment interface, and perform a payment operation for the corresponding merchant. The user can also tap name information of a merchant, to jump to a corresponding payment interface and complete a payment. The user can also tap the function option near the merchant identification information, to complete a payment. For example, a location at which the function option is set can be set based on actual application scenarios.

The merchant identification information can include name information of the merchant, distance information of the merchant, and/or profile information of the merchant. The name information of the merchant should be consistent with actual store name information of the merchant, so that the user can quickly and accurately find a merchant that needs to be paid, to improve payment efficiency and a payment success rate. For example, if user A shops in a physical merchant store, and a store name of the physical merchant store is convenience store A, when merchant identification information of the convenience store is displayed to the user, a name of the merchant identification information should be convenience store A, so that the user can quickly and accurately find convenience store A and make a payment.

It should be understood that in the method described in one or more implementations of the present specification, orders of some steps in the method can be exchanged with each other based on an actual requirement, or some steps in the method can be omitted or deleted.

In the method in FIG. 3, the at least one device identifier is obtained, which is found based on the Bluetooth and is sent by the user terminal; the merchant identification information corresponding to the at least one device identifier is determined; the merchant identification information is sent to the payment merchant selection interface of the user terminal for display; and the user can select, in the payment merchant selection interface of the user terminal, merchant identification information for making a payment, to jump to a payment interface to make a payment. In an entire process, the user does not need to turn on a camera to perform a scanning operation, and the user directly selects, in the interface of the user terminal, the merchant identification information that needs to be paid to complete a payment. This can improve payment efficiency and a payment success rate of the user.

Based on the method in FIG. 3, an implementation of the present specification further provides some implementation solutions, which are described herein.

In some implementations, after the sending the merchant identification information to the payment merchant selection interface of the user terminal for display, the method can further include: obtaining merchant identification information of a target merchant that is sent by the user terminal, where the target merchant is a merchant corresponding to merchant identification information selected in the payment merchant selection interface of the user terminal; determining collection account information corresponding to the merchant identification information of the target merchant based on the merchant identification information of the target merchant; obtaining payment information sent by the user terminal, where the payment information includes a payment amount; and sending a resource corresponding to the payment amount to an account corresponding to the collection account information.

The above step is an operation process of receiving the merchant selected by the user and making a payment after the user performs selection in the payment merchant selection interface of the user terminal. The user can select, in the payment merchant selection interface, the merchant identification information of the target merchant that needs to be paid. The server determines the collection account information of the target merchant based on the merchant identification information selected by the user, and jumps to a payment interface. The user enters the payment amount by using the mobile terminal in the payment interface, and taps OK to complete a payment.

In some implementations, the device identifier can be obtained through conversion based on a collection two-dimensional code of the merchant; and before the obtaining the at least one device identifier that is found based on the Bluetooth manner and that is sent by the user terminal, the method can further include: obtaining collection code information of the merchant; converting the collection code information into a character string; encrypting the character string to obtain encrypted character string information; and storing the encrypted character string information as a device identifier of the merchant.

In some implementations, the merchant can enter the payment application, complete a merchant registration service on an application page, and agree to enable a Bluetooth payment service. After the merchant agrees to enable the Bluetooth payment service, the server can obtain the collection code information of the merchant, and convert a collection code into a character string. When the collection code is generated, a merchant name and account information of the merchant can be obtained, and then converted into a corresponding binary sequence; a pixel value of each valid information bit in a generation area of the payment code is determined based on the binary sequence, where the generation area of the two-dimensional code further includes a positioning area; and the collection two-dimensional code can be generated based on the pixel value of the valid information bit and a known pixel value of a positioning point bit. Therefore, after the collection two-dimensional code of the merchant is obtained, the collection two-dimensional code can be converted into a sequence character string based on a generation rule.

In some implementations, the character string obtained by converting the collection code of the merchant can be directly stored as the merchant device identifier. The character string includes name information of the merchant and some real-name registration information, and the information is unique and cannot be easily tampered with. Therefore, based on this, information security can be further enhanced. After encryption or another processing operation is performed on the character string, the character string can be stored as the merchant device identifier. For example, the character string can be encrypted in a symmetric encryption manner.

In some implementations herein, the character string obtained by converting the collection code of the merchant is used as the merchant device identifier, so that the server can quickly identify the merchant device identifier, and parse the merchant device identifier to obtain merchant information, which helps to quickly complete a transaction. The character string is encrypted and then used as the merchant identifier, which improves transaction efficiency and ensures security of the merchant information.

Certainly, in addition to the above manner, security of the merchant information can be further improved by using a secure digital certificate. For example, a digital certificate with an audio interface is applied to a mobile phone, and when a payment is made by using the mobile phone, payment data is signed and authenticated by using the digital certificate, to prevent theft and tampering.

A dynamic cipherer can be further used. The dynamic cipherer uses a security authentication algorithm to implement one-time encryption. This can fully ensure security of a payment password on the mobile phone.

In some implementations, before the obtaining the collection code information of the merchant, the method can further include: for a merchant that has completed a merchant registration service, obtaining a Bluetooth payment enabling operation performed by the merchant; and enabling a Bluetooth payment service for the merchant based on the Bluetooth payment enabling operation.

For a merchant that has completed the merchant registration service, identity information of the merchant can be determined. After information indicating that the merchant agrees to enable a Bluetooth payment is received, the Bluetooth payment service is enabled for the merchant. An example operation in which the merchant agrees to enable the Bluetooth payment can be as follows: The user manually enables a Bluetooth payment function option in the payment application, for example, taps the Bluetooth payment function option, so that the Bluetooth payment function option is in an enabled state. Alternatively or additionally, the server can send a Bluetooth payment enabling agreement to the merchant. If the merchant taps an “agree” or “OK” option, it is determined that the merchant agrees to enable the Bluetooth payment service.

For a merchant agreeing to enable the Bluetooth payment service, a Bluetooth function of the merchant can be in an enabled state for a long time. Certainly, in an actual solution, the Bluetooth function of the merchant can be enabled based on an enabling instruction of the server. For example, when detecting that a user enters the Bluetooth payment service, the server performs a Bluetooth search process, and can indicate, when the merchant is within a search range, the merchant to enable the Bluetooth function.

In some implementations, the Bluetooth payment service is enabled for the merchant, to ensure that the merchant can be found by a user who needs to make a Bluetooth payment within a determined range, to improve payment efficiency.

For the user terminal, when the user terminal accesses a Bluetooth payment application, the user terminal can automatically enable a Bluetooth search function. Before the obtaining identification information of at least one merchant that is sent by the user terminal, the method can further include: obtaining access information of the user terminal for a target application; and sending a Bluetooth search enabling instruction to the user terminal based on the access information.

In some implementations, the merchant identification information can include name information of the merchant and distance information of the merchant; and the sending the merchant identification information to the user terminal for display can, for example, include: sending the name information of the merchant and the distance information of the merchant to the user terminal for display.

In some implementations, the server can display the name information and the distance information of the merchant in the merchant selection interface of the user terminal, to notify the user of surrounding merchant information. When displaying the merchant identification information, the server should display at least the name information of the merchant. The name information needs to be consistent with an actual store name of the merchant.

Further, a plurality of display approaches can be included during display.

Display approach 1: Profile information, name information, and/or distance information of merchants can be sorted by distance, and then displayed from top to bottom to the user.

The sending the name information of each merchant and the distance information of each merchant to the user terminal for display can, for example, include: sorting merchants in ascending order of distances based on the distance information; and sending sorted merchant identification information to the user terminal for display.

Display approach 2: The profile information, the name information, and/or the distance information of the merchant are/is displayed to the user in a visual view form, including but not limited to a diagram form, a dynamic diagram form, a voice form, a text form, and the like. To improve user experience, one or more pieces of the merchant identification information to be displayed for the user can be selected based on an actual application scenario, and different display manners are selected to display the merchant identification information that can be selected to the user.

In the display approaches, abundant display manners can improve user experience, so that the user can more quickly and accurately find the merchant identification information that needs to be paid, and complete a payment as soon as possible, to improve payment efficiency and a payment success rate.

In some implementations, the distance information of the merchant can be used to indicate a distance between the merchant and the user terminal; and before the sending the name information of the merchant and the distance information of the merchant to the user terminal for display, the method can further include: obtaining first location coordinate information of the user terminal that is uploaded by the user terminal; obtaining second location coordinate information of the merchant that is uploaded by the merchant; and calculating the distance between the merchant and the user terminal based on the first location coordinate information and the second location coordinate information, to obtain the distance information of the merchant.

In some implementations, before the merchant information is displayed to the user, an actual distance value between each found merchant and the user is calculated, and the merchant(s) is displayed based on the distance value.

In practice, location information of each merchant can be pre-stored on a server side. After a device identifier of each merchant that is uploaded by the user terminal is received, a distance between each merchant and the user terminal can be calculated based on the pre-stored location information of the merchant. When the location information of each merchant is pre-stored, and when a location of the merchant changes, the merchant can actively upload new location information, so that the server updates the stored location information of the merchant.

In addition, the merchant can periodically upload the location information of the merchant, so that the server updates the location information of the merchant. The merchant can further upload the location information based on an instruction of the server, that is, upload the location information of the merchant after receiving a location information uploading instruction sent by the server. The location information can include distance information, and the location information can further include location coordinate information.

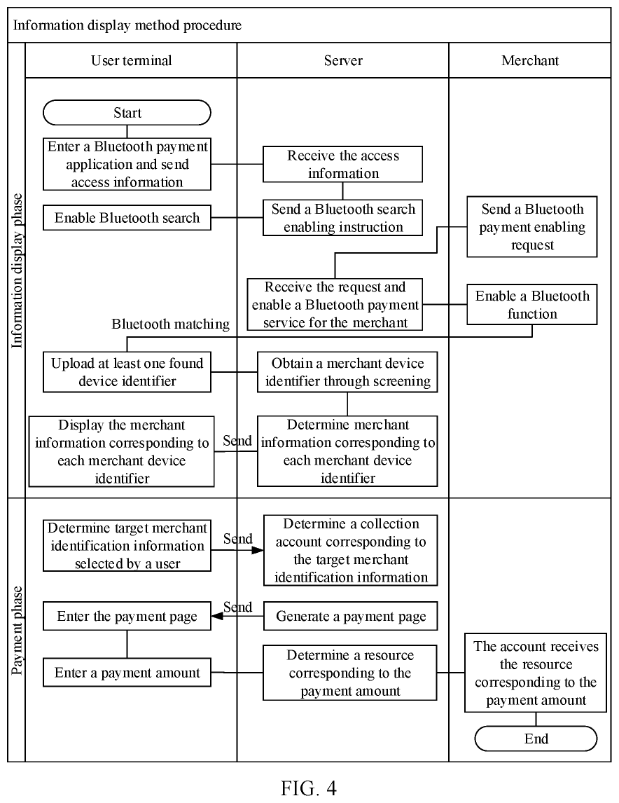

The methods in the foregoing implementations can be described based on FIG. 4.

FIG. 4 is a lane diagram illustrating an information prompting method according to an implementation of the present specification. As shown in FIG. 4, involved interaction subjects include a user terminal, a server, and a merchant. An implementation process can be divided into an information display phase and a payment phase. For an interaction process, references can be made to the following implementation steps: Information display phase: The user terminal enters a Bluetooth payment application interface. The server receives access information of the user terminal, and sends a Bluetooth search enabling instruction to the user terminal. The user terminal automatically enables a Bluetooth search function based on the Bluetooth search enabling instruction to implement search. The merchant requests to enable a Bluetooth payment service in a payment application. After the server enables the Bluetooth payment service for the merchant, the merchant automatically enables a Bluetooth function. The user terminal uploads at least one found device identifier to the server. The server obtains a merchant device identifier in the device identifier through screening, determines merchant identification information corresponding to each merchant device identifier, and sends each piece of merchant identification information to the user terminal for display.

Payment phase: The user terminal displays each piece of merchant identification information in a payment merchant selection interface. A user taps a store name or a profile on a mobile phone, and selects target merchant identification information that needs to be paid. The user terminal sends the target merchant identification information selected by the user to the server. The server determines a collection account corresponding to the merchant identification information. The user terminal jumps to a payment page, the user enters a payment amount, and the server sends a resource corresponding to the user amount to the collection account of the target merchant. When standing in front of a checkout counter, the user directly takes out the mobile phone and taps the store name on a screen to make a payment. This reduces a step of scanning a code by the mobile phone.

It should be noted that in some implementations of the present specification, the Bluetooth payment can be an application, or a small program application or a function option in the payment application.

Power consumption of Bluetooth is low. For example, the user terminal automatically searches for a surrounding Bluetooth device name within each determined duration, and a search range is a determined distance range. A long string of digits in the device name is decrypted to obtain merchant information.

When display is performed on the user terminal, if the user is located in a shopping mall with a relatively large quantity of merchants, a list of all payable merchants can be displayed. The user taps to select corresponding merchant information to make a payment. If there is only one merchant in the Bluetooth search range of the location of the user, a direct jump to a corresponding merchant can be made to enable the user to make a payment.

The methods in the foregoing implementations can achieve the following technical effects:
(1) The merchant does not need to provide a two-dimensional code, and needs only one Bluetooth device. There is no need to worry about a problem of maliciously covering the two-dimensional code and a problem of damaging and identifying the two-dimensional code.
(2) A Bluetooth connection is a near field connection, and needs no Internet network.
(3) There is no code scanning and impact of light and a distance.
(4) After identifying a device id, Bluetooth initiates identification and extraction of the merchant information to the server like the two-dimensional code. A matching and security capability of the server can also be applied to a Bluetooth payment.
(5) The at least one device identifier that is found based on the Bluetooth manner and that is sent by the user terminal is obtained; the merchant identification information corresponding to the at least one device identifier is determined; the merchant identification information is sent to the payment merchant selection interface of the user terminal for display; and the user can select, in the payment merchant selection interface of the user terminal, merchant identification information for making a payment, to jump to a payment interface to make a payment. In an entire process, the user does not need to turn on a camera to perform a scanning operation, and the user directly selects, in the interface of the user terminal, the merchant identification information that needs to be paid to complete a payment. This can improve payment efficiency and a payment success rate of the user.

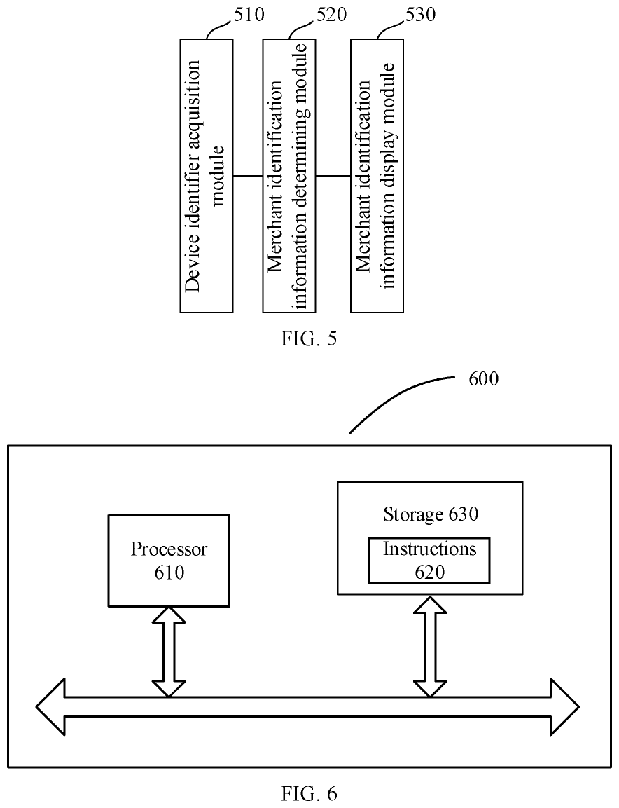

An implementation of the present specification further provides an apparatus corresponding to the above method. FIG. 5 is a schematic diagram illustrating a structure of an information display apparatus according to an implementation of the present specification. As shown in FIG. 5, the apparatus can include: a device identifier acquisition module 510, configured to obtain at least one device identifier that is found based on a Bluetooth manner and that is sent by a user terminal; a merchant identification information determining module 520, configured to determine merchant identification information corresponding to the at least one device identifier; and a merchant identification information display module 530, configured to send the merchant identification information to a payment merchant selection interface of the user terminal for display, where the payment merchant selection interface is configured to provide the user terminal with merchant identification information that can be selected to make a payment.

Based on the apparatus in FIG. 5, an implementation of the present specification further provides some implementation solutions of the apparatus, which are described below.

In some implementations, the apparatus can further include: a target merchant identification information acquisition module, configured to obtain merchant identification information of a target merchant that is sent by the user terminal, where the target merchant is a merchant corresponding to merchant identification information selected in the payment merchant selection interface of the user terminal; a collection account information determining module, configured to determine collection account information corresponding to the merchant identification information of the target merchant based on the merchant identification information of the target merchant; a payment information acquisition module, configured to obtain payment information sent by the user terminal, where the payment information includes a payment amount; and a payment module, configured to send a resource corresponding to the payment amount to an account corresponding to the collection account information.

In some implementations, the device identifier can be obtained through conversion based on a collection two-dimensional code of the merchant; and the apparatus can further include: a collection code information acquisition module, configured to obtain collection code information of the merchant; a character string determining module, configured to convert the collection code information into a character string; an encryption module, configured to encrypt the character string to obtain encrypted character string information; and a device identifier storage module, configured to store the encrypted character string information as a device identifier of the merchant.

In some implementations, the apparatus can further include: a Bluetooth payment enabling operation acquisition module, configured to: for a merchant that has completed a merchant registration service, obtain a Bluetooth payment enabling operation performed by the merchant; and a Bluetooth payment service enabling module, configured to enable a Bluetooth payment service for the merchant based on the Bluetooth payment enabling operation.

In some implementations, the merchant identification information includes name information of the merchant and distance information of the merchant; and the merchant identification information display module 530 can, for example, include a display unit, configured to send the name information of the merchant and the distance information of the merchant to the user terminal for display.

In some implementations, the display unit can, for example, include: a sorting subunit, configured to sort merchants in ascending order of distances based on the distance information; and a display subunit, configured to send sorted merchant identification information to the user terminal for display.

In some implementations, the distance information of the merchant can be used to indicate a distance between the merchant and the user terminal; and the merchant identification information display module 530 can further include: a first location coordinate information acquisition unit, configured to obtain first location coordinate information of the user terminal that is uploaded by the user terminal; a second location coordinate information acquisition unit, configured to obtain second location coordinate information of the merchant that is uploaded by the merchant; and a distance information calculation unit, configured to calculate the distance between the merchant and the user terminal based on the first location coordinate information and the second location coordinate information, to obtain the distance information of the merchant.

In some implementations, the merchant identification information determining module 520 can, for example, include: a correspondence acquisition unit, configured to obtain a pre-stored correspondence between a device identifier and merchant identification information; and a merchant identification information determining unit, configured to determine the merchant identification information corresponding to the at least one device identifier based on the correspondence.

In some implementations, the merchant identification information determining module 520 can, for example, include a character string parsing unit, configured to parse a character string corresponding to the device identifier, to determine merchant identification information included in the character string.

In some implementations, the apparatus can further include: an access information acquisition module, configured to obtain access information of the user terminal for a target application; and a Bluetooth search enabling instruction sending module, configured to send a Bluetooth search enabling instruction to the user terminal based on the access information.

Based on the same idea, an implementation of the present specification further provides a device corresponding to the above method.

FIG. 6 is a schematic diagram illustrating a structure of an information display device according to an implementation of the present specification. As shown in FIG. 6, the device 600 can include at least one processor 610 and a storage 630 communicatively connected to the at least one processor. The storage 630 stores instructions 620 that can be executed by the at least one processor 610. The instructions are executed by the at least one processor 610, to enable the at least one processor 610 to perform the following operations: obtaining at least one device identifier that is found based on a Bluetooth manner and that is sent by a user terminal; determining merchant identification information corresponding to the at least one device identifier; and sending the merchant identification information to a payment merchant selection interface of the user terminal for display, where the payment merchant selection interface is configured to provide the user terminal with merchant identification information that can be selected to make a payment.

Based on the same idea, an implementation of the present specification further provides a computer-readable medium corresponding to the above method. The computer-readable medium stores computer-readable instructions. The computer-readable instructions can be executed by a processor to implement the following method: obtaining at least one device identifier that is found based on a Bluetooth manner and that is sent by a user terminal; determining merchant identification information corresponding to the at least one device identifier; and sending the merchant identification information to a payment merchant selection interface of the user terminal for display, where the payment merchant selection interface is configured to provide the user terminal with merchant identification information that can be selected to make a payment.

The implementations of the present specification are described in a progressive manner. For same or similar parts of the implementations, mutual references can be made to the implementations. Each implementation focuses on a difference from the other implementations. Particularly, the device implementations are basically similar to the method implementations, and therefore are described briefly. For related parts, references can be made to parts of the method implementation descriptions.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented in any suitable manner, for example, the controller can use a form such as a microprocessor, a processor, or a computer-readable medium, a logic gate, a switch, an application specific integrated circuit (ASIC), a programmable logic controller, or an embedded microcontroller storing computer-readable program code (such as software or firmware) that can be executed by the (micro)processor. Examples of the controller include but are not limited to the following microcontrollers: ARC 625D, Atmel AT91SAM, Microchip PIC18F26K20, and Silicone Labs C8051F320. A storage controller can also be implemented as a part of control logic of the storage. A person skilled in the art also knows that in addition to implementing the controller by using only the computer-readable program code, logic programming can absolutely be performed on method steps to enable the controller to implement the same function in a form of a logic gate, a switch, an application specific integrated circuit, a programmable logic controller, or an embedded microcontroller. Therefore, the controller can be considered as a hardware component, and an apparatus configured to implement various functions in the controller can also be considered as a structure in the hardware component. Alternatively, an apparatus configured to implement various functions can even be considered as both a software module implementing the method and a structure in the hardware component.

The systems, apparatuses, modules, or units described in the above implementations can be, for example, implemented by a computer chip or an entity, or can be implemented by a product having a certain function. A typical implementation device is a computer. For example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above apparatus is described by dividing functions into various units. Certainly, when the present application is implemented, functions of the units can be implemented in one or more pieces of software and/or hardware.

A person skilled in the art should understand that the implementations of the present invention can be provided as methods, systems, or computer program products. Therefore, the present invention can use a form of hardware only implementations, software only implementations, or implementations with a combination of software and hardware. In addition, the present invention can use a form of a computer program product that is implemented on one or more computer-usable storage media (including but not limited to a disk storage, a CD-ROM, an optical storage, or the like) that include computer-usable program code.

The present invention is described with reference to the flowcharts and/or block diagrams of the method, the device (system), and the computer program product according to the implementations of the present invention. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a function in one or more procedures in the flowcharts and/or in one or more blocks in the block diagrams.

Alternatively, these computer program instructions can be stored in a computer-readable storage that can instruct a computer or another programmable data processing device to work in a manner, so that the instructions stored in the computer-readable storage generate an artifact that includes an instruction apparatus. The instruction apparatus implements a function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM) or another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic tape, a magnetic tape/magnetic disk storage or another magnetic storage device, or any other non-transmission medium that can be used to store information that can be accessed by a computing device. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such process, method, product, or device. Without more constraints, an element limited by the statement “includes a . . . ” does not exclude the existence of additional identical elements in the process, method, product, or device that includes the element.

A person skilled in the art should understand that the implementations of the present application can be provided as methods, systems, or computer program products. Therefore, the present application can use a form of hardware only implementations, software only implementations, or implementations with a combination of software and hardware. In addition, the present application can use a form of a computer program product that is implemented on one or more computer-usable storage media (including but not limited to a disk storage, a CD-ROM, an optical storage, or the like) that include computer-usable program code.

The present application can be described in the general context of computer-executable instructions executed by a computer, for example, a program module. Generally, the program module includes a routine, a program, an object, a component, a data structure, and the like for executing a task or implementing an abstract data type. The present application can alternatively be practiced in distributed computing environments in which tasks are performed by remote processing devices that are connected through a communication network. In the distributed computing environments, the program module can be located in a local and remote computer storage medium including a storage device.

The above descriptions are merely implementations of the present application and are not intended to limit the present application. A person skilled in the art can make various modifications and variations to the present application. Any modifications, equivalent replacements, improvements, and the like made without departing from the spirit and principle of the present application shall fall within the scope of the claims in the present application.

What is claimed is:

1. An information display method, comprising:
obtaining at least one device identifier through a short-range communication channel from a user terminal;
determining merchant identification information corresponding to the at least one device identifier; and
sending the merchant identification information to a payment merchant selection interface of the user terminal for display.

2. The method according to claim 1, after the sending the merchant identification information to the payment merchant selection interface of the user terminal for display, further comprising:
obtaining merchant identification information of a target merchant from the user terminal, wherein the target merchant is a merchant corresponding to merchant identification information displayed in the payment merchant selection interface of the user terminal and selected to make a payment;
determining collection account information corresponding to the merchant identification information of the target merchant based on the merchant identification information of the target merchant;
obtaining payment information from the user terminal, wherein the payment information includes a payment amount; and
sending a resource corresponding to the payment amount to an account corresponding to the collection account information.

3. The method according to claim 1, wherein the at least one device identifier is obtained through conversion based on a collection two-dimensional code of a merchant; and
before the obtaining the at least one device identifier through the short-range communication from the user terminal, the method further comprises:
obtaining collection code information of the merchant;
converting the collection code information into a character string;
encrypting the character string to obtain encrypted character string information; and
storing the encrypted character string information as a device identifier of the merchant.

4. The method according to claim 3, before the obtaining the collection code information of the merchant, further comprising:
for a merchant that has completed a merchant registration service, obtaining a Bluetooth payment enabling operation performed by the merchant; and
enabling a Bluetooth payment service for the merchant based on the Bluetooth payment enabling operation.

5. The method according to claim 1, wherein the merchant identification information includes name information of a merchant and distance information of the merchant; and
the sending the merchant identification information to the user terminal for display includes:
sending the name information of the merchant and the distance information of the merchant to the user terminal for display.

6. The method according to claim 5, wherein the sending the name information of the merchant and the distance information of the merchant to the user terminal for display includes:
sorting merchant identification information based on the distance information; and
sending sorted merchant identification information to the user terminal for display.

7. The method according to claim 5, wherein the distance information of the merchant indicates a distance between the merchant and the user terminal; and
before the sending the name information of the merchant and the distance information of the merchant to the user terminal for display, the method further comprises:
obtaining first location coordinate information of the user terminal that is uploaded by the user terminal;
obtaining second location coordinate information of the merchant that is uploaded by the merchant; and
calculating the distance between the merchant and the user terminal based on the first location coordinate information and the second location coordinate information, to obtain the distance information of the merchant.

8. The method according to claim 1, wherein the determining the merchant identification information corresponding to the at least one device identifier includes:
obtaining a pre-stored correspondence between a device identifier and merchant identification information; and
determining the merchant identification information corresponding to the at least one device identifier based on the pre-stored correspondence.

9. The method according to claim 1, wherein the determining the merchant identification information corresponding to the at least one device identifier includes:
parsing a character string corresponding to a device identifier of the at least one device identifier to determine merchant identification information included in the character string.

10. The method according to claim 1, further comprising:
obtaining access information of the user terminal for a target application; and
sending a Bluetooth search enabling instruction to the user terminal based on the access information.

11. The method according to claim 1, wherein the payment merchant selection interface is configured to display the merchant identification information for a user selection with respect to a payment.

12. A computer system having one or more processors and one or more storage devices, the one or more storage devices, individually or collectively having computer executable instructions stored thereon, the computer executable instructions, when executed by the one or more processors, enabling the one or more processors to, individually or collectively, implement acts comprising:
obtaining at least one device identifier through a short-range communication channel from a user terminal;
determining merchant identification information corresponding to the at least one device identifier; and
sending the merchant identification information to a payment merchant selection interface of the user terminal for display.

13. The computer system according to claim 12, wherein the acts includes:
after the sending the merchant identification information to the payment merchant selection interface of the user terminal for display,
obtaining merchant identification information of a target merchant from the user terminal, wherein the target merchant is a merchant corresponding to merchant identification information displayed in the payment merchant selection interface of the user terminal and selected to make a payment;
determining collection account information corresponding to the merchant identification information of the target merchant based on the merchant identification information of the target merchant;
obtaining payment information from the user terminal, wherein the payment information includes a payment amount; and
sending a resource corresponding to the payment amount to an account corresponding to the collection account information.

14. The computer system according to claim 12, wherein the at least one device identifier is obtained through conversion based on a collection two-dimensional code of a merchant; and
wherein the acts further comprise:
before the obtaining the at least one device identifier through the short-range communication from the user terminal,
obtaining collection code information of the merchant;
converting the collection code information into a character string;
encrypting the character string to obtain encrypted character string information; and
storing the encrypted character string information as a device identifier of the merchant.

15. The computer system according to claim 12, wherein the determining the merchant identification information corresponding to the at least one device identifier includes:
obtaining a pre-stored correspondence between a device identifier and merchant identification information; and
determining the merchant identification information corresponding to the at least one device identifier based on the pre-stored correspondence.

16. The computer system according to claim 12, wherein the determining the merchant identification information corresponding to the at least one device identifier includes:
parsing a character string corresponding to a device identifier of the at least one device identifier to determine merchant identification information included in the character string.

17. The computer system according to claim 12, wherein the acts further comprise:
obtaining access information of the user terminal for a target application; and
sending a Bluetooth search enabling instruction to the user terminal based on the access information.

18. A non-transitory storage medium having computer executable instructions stored thereon, the computer executable instructions, when executed by one or more processors, enabling the one or more processors to, individually or collectively, implement acts comprising:
obtaining at least one device identifier through a short-range communication channel from a user terminal;
determining merchant identification information corresponding to the at least one device identifier; and
sending the merchant identification information to a payment merchant selection interface of the user terminal for display.

19. The non-transitory storage medium according to claim 18, wherein the acts includes:
after the sending the merchant identification information to the payment merchant selection interface of the user terminal for display,
obtaining merchant identification information of a target merchant from the user terminal, wherein the target merchant is a merchant corresponding to merchant identification information displayed in the payment merchant selection interface of the user terminal and selected to make a payment;
determining collection account information corresponding to the merchant identification information of the target merchant based on the merchant identification information of the target merchant;
obtaining payment information from the user terminal, wherein the payment information includes a payment amount; and
sending a resource corresponding to the payment amount to an account corresponding to the collection account information.

20. The non-transitory storage medium according to claim 18, wherein the at least one device identifier is obtained through conversion based on a collection two-dimensional code of a merchant; and
wherein the acts further comprise:
before the obtaining the at least one device identifier through the short-range communication from the user terminal,
obtaining collection code information of the merchant;
converting the collection code information into a character string;
encrypting the character string to obtain encrypted character string information; and
storing the encrypted character string information as a device identifier of the merchant.
